(19) United States
(12) Patent Application Publication
(10) Pub. No.: US 2026/0206089 A1
(43) Pub. Date: Jul. 16, 2026

(54) METHODS AND APPARATUSES FOR MAINTAINING TA VALUES

(71) Applicant: LENOVO (BEIJING) LIMITED, Beijing (CN)

(72) Inventors: Lianhai Wu, Beijing (CN); Shuigen Yang, Shanghai (CN); Chenxi Zhu, Beijing (CN); Bingchao Liu, Beijing (CN)

(21) Appl. No.: 19/133,872

(22) PCT Filed: Feb. 15, 2023
(86) PCT No.: PCT/CN2023/076205

§ 371 Date: May 29, 2025

(51) Int. Cl. H04W 76/27

(52) U.S. Cl. CPC H04W 76/27

(57) ABSTRACT

Embodiments of the present application relate to methods and apparatuses for maintaining timing advance (TA) values under a 3rd Generation Partnership Project (3GPP) 5G system or the like. According to an embodiment of the present application, a centralized unit (CU) includes a transceiver and a processor coupled to the transceiver, and the processor is configured to: transmit a request for cell switching including identifier (ID) information of one or more candidate cells via the transceiver to one or more candidate distributed units (DU) s of the BS; receive radio resource control (RRC) configuration information for the one or more candidate cells via the transceiver from the one or more candidate DUs; and transmit an RRC reconfiguration message associated with the one or more candidate cells via the transceiver to a user equipment (UE).

WO

### TECHNICAL FIELD

Embodiments of the present application generally relate to wireless communication technology, especially to methods and apparatuses for maintaining timing advance (TA) values in a cell switching procedure.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g. time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Currently, details regarding how to maintain timing advance (TA) values in a cell switching procedure have not been discussed in 3GPP 5G technology yet.

### SUMMARY

Some embodiments of the present application provide a centralized unit (CU). The CU includes a transceiver and a processor coupled to the transceiver; and the processor is configured to: transmit a request for cell switching including identifier (ID) information of one or more candidate cells via the transceiver to one or more candidate distributed units (DU)s of the BS; receive radio resource control (RRC) configuration information for the one or more candidate cells via the transceiver from the one or more candidate DUs; and transmit an RRC reconfiguration message associated with the one or more candidate cells via the transceiver to a user equipment (UE).

In some embodiments, the processor of the CU is configured to: receive a first message via the transceiver from the UE or from a candidate DU within the one or more candidate DUs, wherein the UE is configured to switch from a source cell to a candidate cell within the one or more candidate cells; and in response to receiving the first message, transmit a request for providing a timing advance (TA) list via the transceiver to a source DU, wherein the TA list includes at least one of the following: one or more TA values associated with the one or more candidate cells; or ID information of the one or more candidate cells.

In some embodiments, the first message includes at least one of the following: information to indicate that the UE has switched to the candidate cell; or a request of the TA list.

In some embodiments, the processor of the CU is configured to: receive the TA list via the transceiver from the source DU; and transmit the TA list via the transceiver to the candidate DU.

In some embodiments, the processor of the CU is configured to: receive one or more timing advance (TA) values associated with the one or more candidate cells via the transceiver from the one or more candidate DUs; and store the one or more TA values.

In some embodiments, the processor of the CU is configured to transmit a TA list of the UE via the transceiver to a candidate DU of the BS, wherein the UE is configured to switch from a source cell of a source DU of the BS to a candidate cell of the candidate DU, and wherein the TA list includes at least one of the following: the one or more TA values; or ID information of the one or more candidate cells.

In some embodiments, the TA list is transmitted after the processor of the CU is configured to receive one of the following: information via the transceiver from the source DU to indicate that a cell switching command has been transmitted from the source DU to the UE; an RRC reconfiguration complete message via the transceiver from the UE via the candidate DU of the BS; and information via the transceiver from the UE via the candidate DU to indicate that the UE has switched to the candidate cell.

In some embodiments, in response to the UE switching from a source cell to a candidate cell within the one or more candidate cells, the processor of the CU is configured to indicate ID information of the candidate cell to other candidate DUs within the one or more candidate cells.

In some embodiments, the processor of the CU is configured to receive, via the transceiver, at least one of the following: information from the UE via the candidate DU to indicate that the UE has switched to the candidate cell; information from a candidate DU of the BS to indicate that the candidate DU has received a Layer2 (L2) cell switching complete message associated with the candidate cell; or ID information of the one or more candidate cells and ID information of the candidate cell from the source DU.

Some embodiments of the present application provide a user equipment (UE). The UE includes a transceiver and a processor coupled to the transceiver; and the processor is configured to: receive a timing advance (TA) value associated with a source cell via the transceiver from the source cell; receive one or more TA values associated with one or more candidate cells via the transceiver from the one or more candidate cells; receive a cell switching command to a candidate cell within the one or more candidate cells from the source cell; and access the candidate cell based on the cell switching command.

In some embodiments, after the UE switches from the source cell to the candidate cell, the processor of the UE is configured to perform at least one of the following: continuing to keep the TA value associated with the source cell; or maintaining a time alignment timer (TAT) associated with the source cell.

In some embodiments, the source cell acts as one candidate cell after the UE switches from the source cell to the candidate cell.

In some embodiments, the processor of the UE is configured to receive first information via the transceiver from the source cell, and wherein the first information indicates at least one of the following: whether to keep the TA value associated with the source cell; or whether to maintain the TAT associated with the source cell.

In some embodiments, after the UE switches from the source cell to the candidate cell, the processor of the UE is configured to: release the one or more TA values associated with the one or more candidate cells; or continue to keep all or a subset of the one or more TA values associated with the one or more candidate cells.

In some embodiments, in response to continuing to keep the all or the subset of the one or more TA values, the processor of the UE is configured to transmit an identifier (ID) list of a set of candidate cells within the one or more candidate cells via the transceiver to the candidate cell, wherein a TA value associated with each candidate cell within the set of candidate cells is kept by the UE.

In some embodiments, the processor of the UE is configured to receive second information via the transceiver from the source cell, and wherein the second information indicates the UE to keep a TA value of which candidate cell after the UE switches from the source cell to the candidate cell.

Some embodiments of the present application provide a source distributed unit (DU). The source DU includes a transceiver and a processor coupled to the transceiver; and the processor is configured to: receive a timing advance (TA) list via the transceiver from a centralized unit (CU) of the BS, wherein the TA list includes at least one of the following: one or more TA values associated with one or more candidate cells of one or more candidate DUs of the BS; or identifier (ID) information of the one or more candidate cells; and transmit a cell switching command to a candidate cell within the one or more candidate cells via the transceiver to a user equipment (UE).

In some embodiments, the processor of the source DU is configured to: receive a request for providing the TA list via the transceiver from the CU; transmit the TA list via the transceiver to the CU.

In some embodiments, after transmitting the cell switching command, the processor of the source DU is configured to: transmit ID information of the one or more candidate cells via the transceiver to the CU; and transmit ID information of the candidate cell via the transceiver to the CU.

Some embodiments of the present application provide a candidate distributed unit (DU). The candidate DU includes a transceiver and a processor coupled to the transceiver; and the processor is configured to transmit a first message via the transceiver to the CU, wherein the first message includes at least one of the following: information indicating that a user equipment (UE) has switched from a source cell of a source DU of the BS to a candidate cell within a set of candidate cells of the candidate DU; or a request of a timing advance (TA) list.

In some embodiments, wherein the TA list includes at least one of the following: one or more TA values associated with one or more candidate cells of one or more candidate DUs of the BS; or ID information of the one or more candidate cells.

In some embodiments, the processor of the candidate DU is configured to receive the TA list via the transceiver from the CU.

In some embodiments, the TA list is received by the candidate DU from the CU after the CU is configured to receive one of the following: information from the source DU to indicate that a cell switching command has been transmitted from the source DU to the UE; a radio resource control (RRC) reconfiguration complete message from the UE via the candidate DU; and information from the UE via the candidate DU to indicate that the UE has switched to the candidate cell.

In some embodiments, the processor of the candidate DU is configured to: receive the information indicating that the UE has switched from the source cell to the candidate cell via the transceiver from the UE.

In some embodiments, the processor of the candidate DU is configured to: receive a Layer2 (L2) cell switching complete message associated with the candidate cell via the transceiver from the UE; and transmit information via the transceiver to the CU to indicate that the L2 cell switching complete message has been received.

Some embodiments of the present application provide a method performed by a centralized unit (CU). The method includes: transmitting a request for cell switching including identifier (ID) information of one or more candidate cells to one or more candidate distributed units (DU)s of the BS; receiving radio resource control (RRC) configuration information for the one or more candidate cells from the one or more candidate DUs; and transmitting an RRC reconfiguration message associated with the one or more candidate cells to a user equipment (UE).

Some embodiments of the present application provide a method performed by a UE. The method includes: receiving a timing advance (TA) value associated with a source cell from a source cell; receiving one or more TA values associated with one or more candidate cells from one or more candidate cells; receiving a cell switching command to a candidate cell within the one or more candidate cells from the source cell; and accessing the candidate cell based on the cell switching command.

Some embodiments of the present application provide a method performed by a source distributed unit (DU). The method includes: receiving a timing advance (TA) list from a centralized unit (CU) of the BS, wherein the TA list includes at least one of the following: one or more TA values associated with one or more candidate cells of one or more candidate DUs of the BS; or identifier (ID) information of the one or more candidate cells; and transmitting a cell switching command to a candidate cell within the one or more candidate cells to a user equipment (UE).

Some embodiments of the present application provide a method performed by a candidate distributed unit (DU). The method includes: transmitting a first message to the CU, wherein the first message includes at least one of the following: information indicating that a user equipment (UE) has switched from a source cell of a source DU of the BS to a candidate cell within the set of candidate cells; or a request of a timing advance (TA) list.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g. a base station (BS), a CU, or a DU).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates a schematic diagram of inter-cell Layer1/Layer2 (L1/L2) triggered mobility (LTM) in accordance with some embodiments of the present application.

FIG. 3 illustrates an exemplary flowchart of transmitting a request for cell switching in accordance with some embodiments of the present application.

FIG. 4 illustrates an exemplary flowchart of receiving a cell switching command in accordance with some embodiments of the present application.

FIG. 5 illustrates an exemplary flowchart of transmitting a cell switching command in accordance with some embodiments of the present application.

FIGS. 6-9 illustrate exemplary flowcharts of maintaining a TA value in accordance with some embodiments of the present application.

FIG. 10 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g. UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g. a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbor BSs may communicate with each other as necessary, e.g. during a handover procedure for a UE.

UE 102, e.g. UE 102a and UE 102b, should be understood as any type terminal device, which may include computing devices, such as desktop computers, laptop computers, personal digital assistants (PDAs), tablet computers, smart televisions (e.g. televisions connected to the Internet), set-top boxes, game consoles, security systems (including security cameras), vehicle on-board computers, network devices (e.g. routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

In 3GPP Release 18, it has been discussed to support an inter-cell mobility based on Layer1/Layer2 (L1/L2) signaling. In particular, a UE can be provided in advance with configurations from multiple cells, and a BS (e.g. gNB) may switch a UE to a new cell using L1/L2 signaling taking into account the received physical layer measurement result. In accordance with 3GPP standard documents, a BS may consist of a BS-centralized unit (CU) and one or more BS-distributed units (DUs). A BS-CU and a BS-DU are connected via F1 interface which is a logical interface. One BS-DU is connected to only one BS-CU.

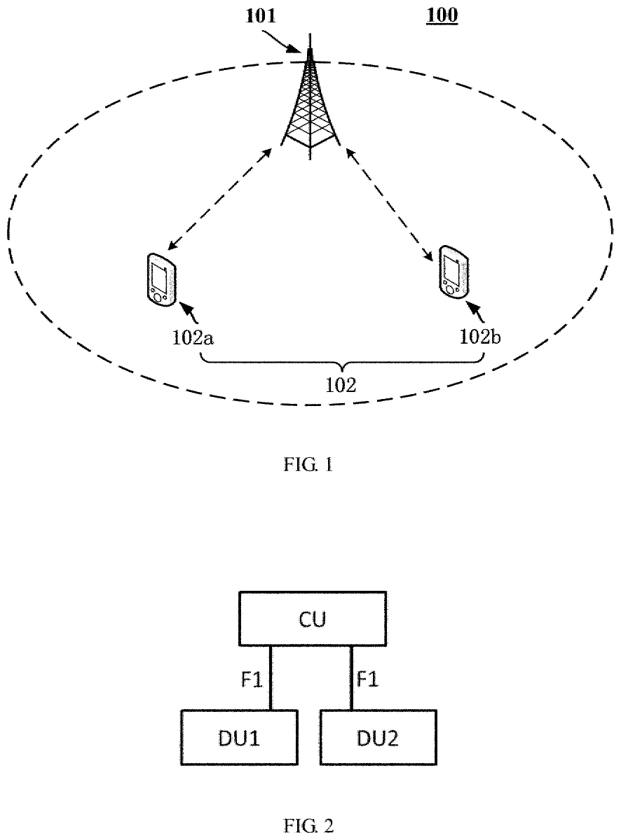

FIG. 2 illustrates a schematic diagram of inter-cell Layer1/Layer2 (L1/L2) triggered mobility (LTM) in accordance with some embodiments of the present application. As shown in FIG. 2, CU may communicate with two DUs, i.e. DU1 or DU2, via F1 interfaces. CU in FIG. 2 may implement legacy mobility decision based on Layer 3 (L3) measurement result. DU1 or DU2 in FIG. 2 may implement L1/L2 triggered mobility decision based on physical layer measurement result.

Compared to legacy L3 based mobility, L1/L2 triggered mobility is considered faster with less processing delay and signaling delay. In legacy L3 based mobility, a CU (e.g. CU as shown in FIG. 2) makes the mobility decision based on received radio resource management (RRM) measurement report. RRC configuration information will be used to trigger L3 based mobility. Different from legacy L3 based mobility, in L1/L2 triggered mobility, a DU (e.g. DU1 or DU2 as shown in FIG. 2) makes the mobility decision based on physical layer measurement result, e.g. carried in a channel state information (CSI) report. A medium access control (MAC) control element (CE) may be used to trigger LTM. Besides, in legacy L3 based mobility, the handover command is sent via an RRC message from the CU to a UE, while in L1/L2 mobility, the “handover” command is sent via L1/L2 signaling (e.g. downlink control information (DCI) or a MACCE) from the DU to a UE. The “handover” command in L1/L2 mobility can be about cell activation or deactivation, e.g. activate a new serving PCell while deactivate the old serving PCell.

Currently, several issues regarding maintaining TA values during L1/L2 mobility need to be solved. The embodiments of the present application aim to solve such issues. Some embodiments of the present application may be applicable for a case of “lower layer triggered mobility” or “L1/L2 triggered mobility”, and the abbreviation of at least one of them may be “LTM”. In an LTM case, a UE may access a serving BS (e.g. a serving gNB). The UE may report Layer3 (L3) measurement result(s) based on the configuration from the serving gNB. If the serving gNB, e.g. a CU of the serving gNB, decides to switch the UE to a candidate cell based on the measurement result(s), the serving gNB may request target DU(s) to prepare the configuration for one or more candidate cells. After receiving the candidate cell configuration from a target DU of the serving gNB, the serving gNB may transmit an RRC reconfiguration message including ID information of one or more candidate cells to the UE. For example, the CU may transmit the RRC reconfiguration message to the UE via a source DU of the serving gNB. The UE may transmit an RRC reconfiguration complete message to the serving gNB (e.g. CU) via the source DU. The UE may ensure UL synchronization or DL synchronization before receiving a cell switch command. For example, the UE may get or acquire a TA value via a random access (RA) or preamble transmission. The UE may report Layer1 (L1) measurement result(s) for a dynamic switching purpose. The serving gNB, e.g. the source DU, may transmit a cell switch command, e.g. a MAC CE or DCI. The UE can apply the RRC reconfiguration message and start a timer upon receiving the lower layer command.

More specifically, some embodiments of the present application study a UE's behaviors regarding whether a UE continues to keep TA value(s) for a source cell after accessing a candidate cell when the UE performs lower layer triggered mobility. Some embodiments of the present application study a mechanism of whether or how should a target cell know what candidate cell(s) a UE has TA value(s) already if no random access response (RAR) response based TA acquisition is used and TA value(s) for other candidate cell(s) can be used after performing lower layer triggered mobility to a candidate cell. Some embodiments of the present application study a mechanism of whether a UE releases TA value(s) for other candidate cell(s) after performing lower layer triggered mobility to a candidate cell. Some embodiments of the present application study a mechanism of whether or how a target cell know what candidate cell a UE has TA value(s) already if the UE keeps TA value(s) for other candidate cell(s) after performing lower layer triggered mobility to a candidate cell. Some embodiments of the present application study a mechanism of whether or how should other candidate cell(s) know the state of cell switching in a UE's side after cell switching to a candidate cell.

Some embodiments of the present application study a use case in which before a UE performs lower layer triggered mobility to a candidate cell, one of the UE, a source DU, and a CU may keep a list of TA values for some candidate cells. Some embodiments of the present application study whether a UE continues to keep TA value(s) for a source cell or other candidate cell(s) (assuming that the UE stores TA value(s) for candidate cell(s)), after the UE performs the lower layer triggered mobility to a candidate cell. Some embodiments of the present application study how to inform a target cell what TA value(s) have been derived already, if a source DU or a CU keeps a list of TA values for condition cell(s). In some embodiments of the present application, after a UE switches from a source cell to a candidate cell, the state of cell switching in the UE side is indicated to other candidate cell(s) which the UE does not access.

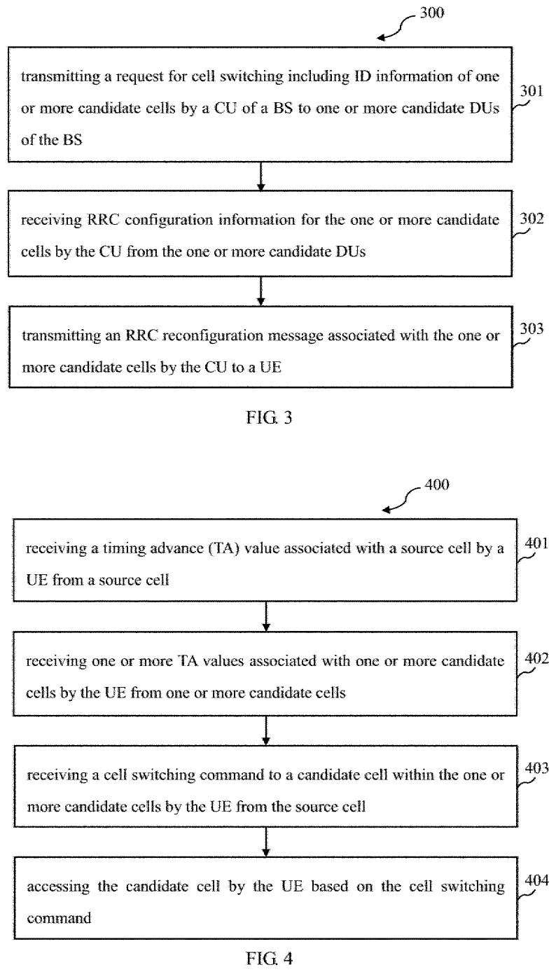

In particular, in embodiments of FIGS. 3-10 of the present application, both inter-DU mobility scenario and intra-DU mobility scenario are considered, e.g. inter-gNB-DU LTM or intra-gNB-DU LTM. Inter-DU mobility means that a connection to a CU remains the same, while a UE may change from a source cell related to a source DU to a target cell related to a target DU due to mobility, while both the source DU and the target DU are managed by the CU. Intra-DU mobility means that a connection to a CU remains the same, while a UE may change from a source cell to a target cell related to the same DU due to mobility. More details will be illustrated in following text in combination with the appended drawings.

FIG. 3 illustrates an exemplary flowchart of transmitting a request for cell switching in accordance with some embodiments of the present application. The exemplary method 300 in the embodiments of FIG. 3 may be performed by a CU of a BS (e.g. CU, CU 604, CU 704, CU 804, or CU 904 as shown and illustrated in any of FIGS. 2 and 6-9). Although described with respect to a CU, it should be understood that other devices may be configured to perform a method similar to that of FIG. 3. Details described in all other embodiments of the present application are applicable for the embodiments of FIG. 3. Moreover, details described in the embodiments of FIG. 3 are applicable for all the embodiments of FIGS. 1, 2, and 4-10.

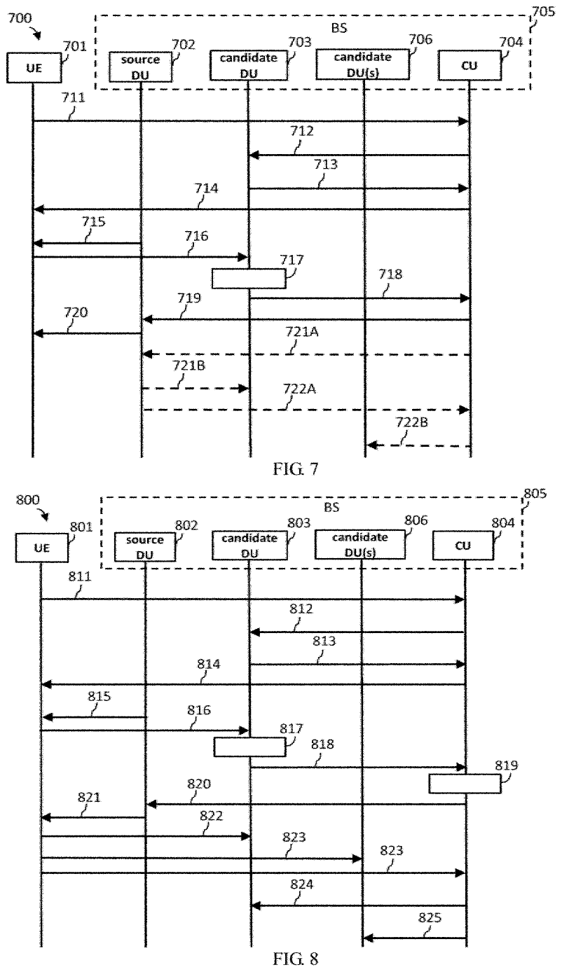

In the exemplary method 300 as shown in FIG. 3, in operation 301, a CU of a BS (e.g. CU 704 or CU 804 as shown and illustrated in FIG. 7 or FIG. 8) transmits a request for cell switching (e.g. a UE CONTEXT SETUP REQUEST message) to one or more candidate DUs of the BS (e.g. candidate DU 703, candidate DU(s) 706, candidate DU 803, or candidate DU(s) 806 as shown and illustrated in FIG. 7 or FIG. 8). The request for cell switching includes ID information of one or more candidate cells.

In operation 302, the CU receives RRC configuration information for the one or more candidate cells from the one or more candidate DUs. In operation 303, the CU transmits an RRC reconfiguration message associated with the one or more candidate cells to a UE (e.g. UE 701 or UE 801 as shown and illustrated in FIG. 7 or FIG. 8).

In some embodiments, the CU may receive a message (denoted message #1 as for simplicity) from the UE or from a candidate DU within the one or more candidate DUs. The UE may be configured to switch from a source cell to a candidate cell (e.g. a target serving cell) within the one or more candidate cells. In response to receiving message #1, the CU may transmit a request for providing a TA list to a source DU (e.g. source DU 702 or source DU 802 as shown and illustrated in FIG. 7 or FIG. 8).

In the embodiments of the present application, a TA list may include a TA value, information of the associated candidate cell, and/or information of the associated candidate DU. For instance, the TA list may include at least one of: (1) one or more TA values associated with the one or more candidate cells, or (2) ID information of the one or more candidate cells.

For instance, message #1 may be received in a scenario without a RAR message for TA acquisition (i.e. no RAR response for TA acquisition), e.g. in a case that the candidate DU calculates the TA and transmits to UE's source DU. Then, the source DU keeps the TA list.

In some embodiments, message #1 includes at least one of: (1) information (e.g. a cell switching success indication) which indicates that the UE has switched to the candidate cell, or (2) a request of the TA list.

In some embodiments, the CU may receive the TA list from the source DU, and transmit the TA list to the candidate DU, e.g. in a scenario without a RAR message for TA acquisition (i.e. no RAR response for TA acquisition).

In some embodiments, the CU may receive one or more TA values associated with the one or more candidate cells from the one or more candidate DUs, and store the one or more TA values, for instance, in a scenario without a RAR message for TA acquisition (i.e. no RAR response for TA acquisition), e.g. in a case that the CU keeps the TA list.

In some embodiments, the CU may transmit a TA list of the UE to a candidate DU of the BS (i.e. a target DU). The UE may be configured to switch from a source cell of a source DU of the BS to a candidate cell (i.e. a target serving cell) of the candidate DU. The TA list may include at least one of: (1) the one or more TA values associated with the one or more candidate cells, or (2) ID information of the one or more candidate cells. For instance, the TA list may be transmitted before or after the UE switches from the source cell to the candidate cell.

In an embodiment, the CU may transmit the TA list after the CU receives information, which indicates that a cell switching command has been transmitted from the source DU to the UE, from the source DU. In another embodiment, the CU may transmit the TA list after the CU receives an RRC reconfiguration complete message from the UE via the candidate DU of the BS. In an additional embodiment, the CU may transmit the TA list after the CU receives information, which indicates that the UE has switched to the candidate cell (e.g. after cell switching is successful), from the UE via the candidate DU.

In some embodiments, if the UE switches from a source cell to a candidate cell within the one or more candidate cells, the CU may indicate ID information of the candidate cell to other candidate DUs within the one or more candidate cells.

In some embodiments, the CU may receive at least one of the following:
(1) information, which indicates that the UE has switched to the candidate cell, from the UE via the candidate DU;
(2) information, which indicates that the candidate DU has received a Layer2 (L2) cell switching complete message (e.g. a MAC CE) associated with the candidate cell, from a candidate DU of the BS (e.g. a target DU); or
(3) ID information of the one or more candidate cells and ID information of the candidate cell from the source DU. Specific examples are described in the embodiments of FIG. 7 or FIG. 8 as follows.

FIG. 4 illustrates an exemplary flowchart of receiving a cell switching command in accordance with some embodiments of the present application. The exemplary method 400 in the embodiments of FIG. 4 may be performed by performed by a UE (e.g. UE 102, UE 601, UE 701, UE 801, or UE 901 as shown and illustrated in any of FIGS. 1 and 6-9). Although described with respect to a UE, it should be understood that other devices may be configured to perform a method similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-10.

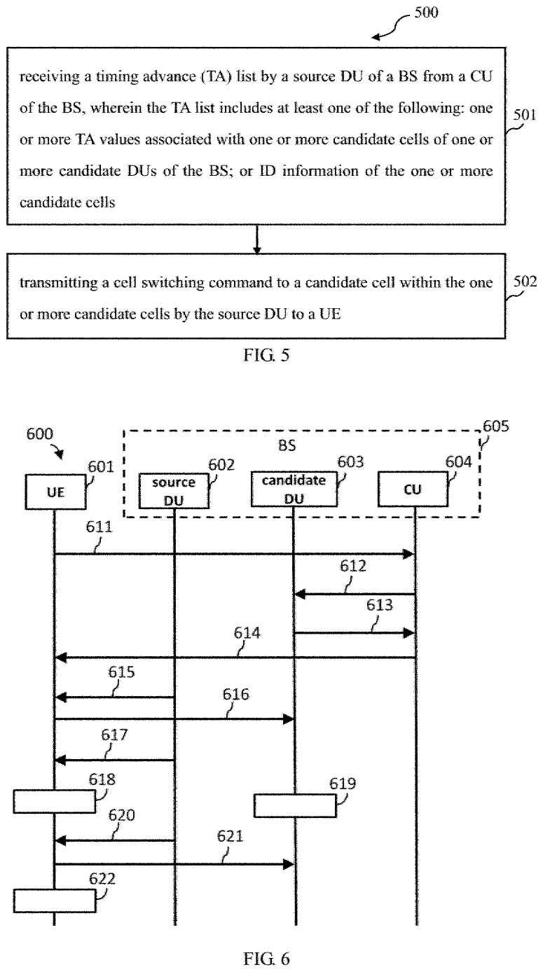

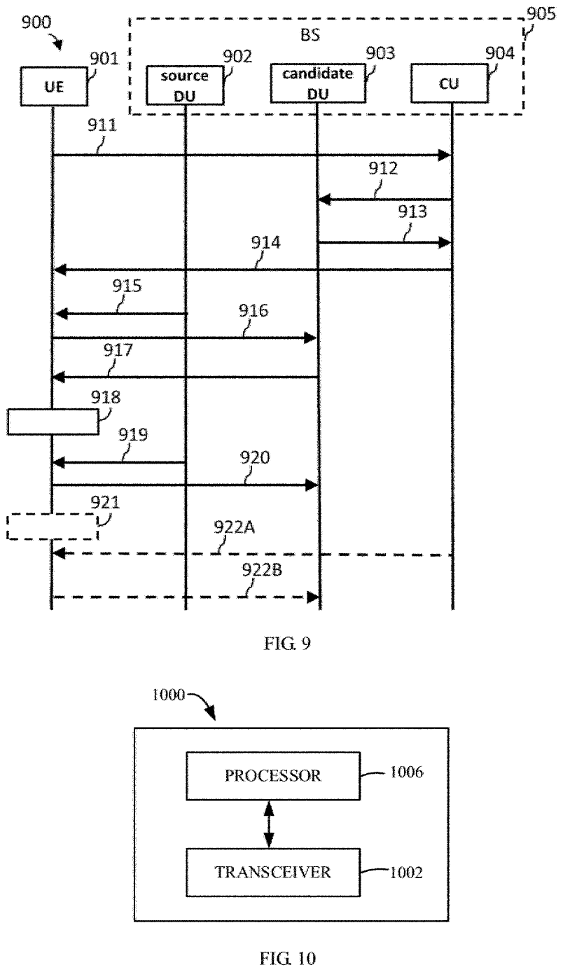

In the exemplary method 400 as shown in FIG. 4, in operation 401, a UE (e.g. UE 601 or 901 as shown and illustrated in FIG. 6 or FIG. 9) may receive a TA value which is associated with a source cell (e.g. a cell of source DU 602 or a cell of source DU 902 as shown and illustrated in FIG. 6 or FIG. 9) from the source cell. In operation 402, the UE may receive one or more TA values which are associated with one or more candidate cells (e.g. candidate cell(s) of candidate DU 603 or candidate cell(s) of candidate DU 903 as shown and illustrated in FIG. 6 or FIG. 9) from the one or more candidate cells. For example, the TA value associated with the source cell and/or the TA value(s) associated with candidate cell(s) may be an absolute TA value or an offset TA value.

In operation 403, the UE may receive a cell switching command to a candidate cell within the one or more candidate cells from the source cell. In operation 404, the UE may access the candidate cell based on the cell switching command.

In some embodiments, after the UE switches from the source cell to the candidate cell (e.g. a target cell), the UE may continue to keep the TA value associated with the source cell and/or maintain a time alignment timer (TAT) associated with the source cell. In an embodiment, the source cell acts as one candidate cell after the UE switches from the source cell to the candidate cell (e.g. the target cell).

In an embodiment, the UE may receive, from the source cell, information which indicates at least one of the following: (1) whether to keep the TA value associated with the source cell; or (2) whether to maintain the TAT associated with the source cell. The information may be included in RRC configuration information.

In some embodiments, after the UE switches from the source cell to the candidate cell, e.g. in a scenario with a RAR message in a case that the UE keeps a TA list, the UE may release the one or more TA values associated with the one or more candidate cells, or the UE may continue to keep all or a subset of the one or more TA values associated with the one or more candidate cells. In an embodiment, if the UE continues to keep all or the subset of the one or more TA values, the UE may transmit an ID list of a set of candidate cells within the one or more candidate cells to the candidate cell (e.g. the target cell). A TA value associated with each candidate cell within the set of candidate cells may be kept by the UE. That is, the UE informs the target cell an ID list of candidate cell(s) whose TA value(s) have been kept by the UE.

In some embodiments, the UE may receive, from the source cell, information which indicates or instruct the UE to keep a TA value of which candidate cell after the UE switches from the source cell to the candidate cell. For example, the information indicates an ID list of candidate cell(s) whose TA value(s) need to be kept by the UE. The information may be included in RRC configuration information. Specific examples are described in the embodiments of FIG. 6 or FIG. 9 as follows.

FIG. 5 illustrates an exemplary flowchart of transmitting a cell switching command in accordance with some embodiments of the present application. The exemplary method 500 in the embodiments of FIG. 5 may be performed by a source DU of a BS (e.g. DU1, DU2, source DU 602, source DU 702, source DU 802, or source DU 902 as shown and illustrated in any of FIGS. 2 and 6-9). Although described with respect to a source DU, it should be understood that other devices may be configured to perform a method similar to that of FIG. 5. Details described in all other embodiments of the present application are applicable for the embodiments of FIG. 5. Moreover, details described in the embodiments of FIG. 5 are applicable for all the embodiments of FIGS. 1-4 and 6-10.

In the exemplary method 500 as shown in FIG. 5, in operation 501, a source DU (e.g. source DU 702 as shown and illustrated in FIG. 7) may receive a TA list from a CU of the BS (e.g. CU 704 as shown and illustrated in FIG. 7). The TA list may include at least one of the following: (1) one or more TA values associated with one or more candidate cells of one or more candidate DUs of the BS; or (2) ID information of the one or more candidate cells. In some embodiments, the source DU may receive a request for providing the TA list from the CU and transmit the TA list to the CU.

In operation 502, the source DU may transmit a cell switching command to a candidate cell (e.g. a target cell) within the one or more candidate cells to a UE (e.g. UE 701 as shown and illustrated in FIG. 7). In some embodiments, after transmitting the cell switching command, the source DU may transmit ID information of the one or more candidate cells to the CU, and transmit ID information of the candidate cell (e.g. the target cell) to the CU. Based on the ID information received from the source DU, the CU may know which candidate cell is the target cell among the one or more candidate cells. A specific example is described in the embodiments of FIG. 7 as follows.

It should be appreciated by persons skilled in the art that the sequence of the operations in any of exemplary procedures 300, 400, and 500 may be changed and some of the operations in any of exemplary procedures 300, 400, and 500 may be eliminated or modified, without departing from the spirit and scope of the disclosure.

Some other embodiments of the present application refer to an exemplary flowchart performed by a candidate DU of a BS (e.g. DU1, DU2, candidate DU 603, candidate DU 703, candidate DU(s) 706, candidate DU 803, candidate DU(s) 806, or candidate DU 903 as shown and illustrated in any of FIGS. 2 and 6-9). Although described with respect to a candidate DU, it should be understood that other devices may be configured to perform a method similar to this exemplary flowchart. Details described in all other embodiments of the present application are applicable for this exemplary flowchart. Moreover, details described in the embodiments of this exemplary flowchart are applicable for all the embodiments of FIGS. 1-10. It should be appreciated by persons skilled in the art that the sequence of the operations in this exemplary flowchart may be changed and some of the operations may be eliminated or modified, without departing from the spirit and scope of the disclosure.

In particular, in this exemplary flowchart, a candidate DU (denoted as candidate DU #1 for simplicity) may transmit a message to the CU. The message may include at least one of the following:
(1) Information (e.g. a cell switching success indication) which indicates that a UE has switched from a source cell of a source DU of the BS to a candidate cell (e.g. a target cell) within a set of candidate cells of candidate DU #1.
(2) A request of a TA list.

In some embodiments, the TA list includes at least one of: (1) TA value(s) associated with candidate cell(s) of candidate DU(s) of the BS; or (2) ID information of the one or more candidate cells. The candidate DU(s) may include candidate DU #1 and/or other candidate DU(s). If the candidate DU(s) only includes candidate DU #1, the candidate cell(s) of the candidate DU(s) are the set of candidate cells of candidate DU #1. If the candidate DU(s) includes candidate DU #1 and other candidate DU(s), the candidate cell(s) of the candidate DU(s) include both the set of candidate cells of candidate DU #1 and candidate cell(s) of the other candidate DU(s).

In some embodiments, candidate DU #1 may receive the TA list from the CU, e.g. in a case that a source DU keeps the TA list or in a case that the CU keeps the TA list. For instance, the CU may receive the TA list from the source DU. The TA list may be received by candidate DU #1 from the CU before or after the UE switches from the source cell to the candidate cell.

In some embodiments, candidate DU #1 may receive the TA list from the CU after the CU receives one of the following:
(1) information, which indicates that a cell switching command has been transmitted from the source DU to the UE, from the source DU;
(2) an RRC reconfiguration complete message from the UE via the candidate DU; and
(3) information, which indicates that the UE has switched to the candidate cell (e.g. the target cell), from the UE via the candidate DU.

In some embodiments, candidate DU #1 may receive the information, which indicates that the UE has switched from the source cell to the candidate cell (e.g. the target cell), from the UE.

In some embodiments, candidate DU #1 may receive a Layer2 (L2) cell switching complete message (e.g. a MAC CE) associated with the candidate cell (e.g. the target cell) from the UE, and transmit information, which indicates that the L2 cell switching complete message has been received, to the CU.

The following text describes specific embodiments of the flowchart as shown and illustrated in any of FIGS. 3-5 or the exemplary flowchart performed by a candidate DU as described above. It should be appreciated by persons skilled in the art that the sequence of the operations in any of exemplary flowcharts 600, 700, 800, and 900 in FIGS. 6-9 may be changed and some of the operations in any of exemplary flowcharts 600, 700, 800, and 900 in FIGS. 6-9 may be eliminated or modified, without departing from the spirit and scope of the disclosure.

FIG. 6 illustrates an exemplary flowchart of maintaining a TA value in accordance with some embodiments of the present application. Details described in all other embodiments of the present application are applicable for the embodiments shown in FIG. 6.

As shown in FIG. 6, BS 605 is in CU-DU architecture, and includes CU 604, source DU 602, and candidate DU 603. In the embodiments shown in FIG. 6, a cell switch or change of UE 601 may refer to an Intra-DU case in which a source cell and a target cell in the same DU or refer to an Inter-DU case in which a source cell and a target cell are located at different DUs. For instance, the flowchart 600 as shown in FIG. 6 only shows a cell change in an Inter-DU case for the exemplary purpose.

In the exemplary flowchart 600 as shown in FIG. 6, in operation 611, UE 601 may access the serving BS (e.g. gNB) and send a measurement report to the serving BS, for example, BS 605. The serving BS may include a CU (e.g. gNB-CU) and one or more DUs (e.g. gNB-DUs). A serving cell is associated with a CU and a DU. There is an F1 interface between the DU and the CU. For example, as shown in FIG. 6, BS 605 includes CU 604, source DU 602, and candidate DU 603. BS 605 may include one or more other candidate DUs (not shown in FIG. 6).

In operation 612, CU 604 may determine to initiate inter-cell L1/L2 based triggered mobility (LTM) configuration and transmit a request message, e.g. a UE CONTEXT SETUP REQUEST message, to candidate DU(s) (e.g. candidate DU 603) which are associated with candidate cell(s). For example, the request message may be named as “a request for cell switching” or “the request of LTM configuration” or the like, and may include ID information of candidate cell(s).

In the exemplary flowchart 600, a subsequent LTM procedure after a LTM procedure may be supported. For instance, after a cell switching procedure, UE 601 may continue to keep candidate cell configuration(s) associated with some candidate cell(s) for subsequent LTM purpose. In some embodiments, CU 604 may transmit a candidate cell list to UE 601, e.g. in operation 612, and UE 601 may store candidate cell configuration(s) associated with each candidate cell within the candidate cell list after UE 601 switches from the source serving cell to a target cell (e.g. a candidate cell of candidate DU 603). UE 601 may switch from the target cell to another target cell (i.e. performing a subsequent LTM procedure) by using the stored candidate cell configuration(s) associated with the candidate cell list. The candidate cell list for which UE 601 will store candidate cell configuration(s) after cell switching may be indicated to a target DU (e.g. candidate DU 603) which UE 601 accesses. The candidate list can be included in a UE CONTEXT SETUP REQUEST message or a UE CONTEXT MODIFICATION REQUEST message.

In operation 613, if candidate DU 603 decides to accept the request of LTM configuration, candidate DU 603 may generate lower layer RRC configuration for the accepted one or more candidate cell(s) and send a response message to CU 604 including the generated lower layer RRC configuration. The response message could be a UE CONTEXT SETUP RESPONSE message.

In operation 614, CU 604 may generate an RRC reconfiguration message based on the configuration for the accepted candidate cell(s) received from candidate DU 603 and transmit the RRC reconfiguration message associated with the candidate cell(s) for LTM configuration to UE 601 via source DU 602.

In operation 615, UE 601 may receive information, which triggers TA acquisition to a candidate cell within the candidate cell(s) (e.g. a candidate cell of candidate DU 603), from source DU 602. In some embodiments, the information could be DCI, a MAC CE or RRC signaling. If the information is DCI, it could be a PDCCH order.

In operation 616, UE 601 may transmit a signal (e.g. a sequence, for instance, a dedicated preamble or a SRS) for TA acquisition, e.g. to candidate DU 603.

In operation 617, UE 601 may receive a TA value from the serving cell. The TA value may be an absolute TA value or an offset of a TA value. For example, the TA value is included in an MAC CE of a timing advance command or an absolute timing advance command, e.g. Timing Advance Command MAC CE or Absolute Timing Advance Command MAC CE. The MAC CE may include an ID of a timing advance group (TAG).

In operation 618, after UE 601 receives the MAC CE of the timing advance command or of the absolute timing advance command with an indicated TAG ID, and if the TA value has been maintained with the indicated TAG ID, UE 601 may apply the timing advance command for the indicated TAG ID. UE 601 may start or restart a time alignment timer (TAT) associated with the indicated TAG ID.

In operation 619, candidate DU 603 may determine to perform LTM based on the received L1 measurement result.

In operation 620, source DU 602 transmits a cell switching command (e.g. a LTM command) to a candidate cell (i.e. a target serving cell) of candidate DU 603 to UE 601.

In operation 621, after UE 601 receives the cell switching command, UE 601 may access the candidate cell of candidate DU 603.

In operation 622, UE 601 may continue to keep the TA value associated with the source cell and/or maintain corresponding a TAT associated with the source cell, if the original source cell (i.e. the original serving cell of source DU 602) still acts as a candidate cell after the cell switch to the candidate cell (i.e. the target serving cell) of candidate DU 603 or if UE 601 has received an indication regarding whether to keep a TA value of the source cell from a network (e.g. CU 604). For example, CU 604 may transmit an indication in operation 614 to indicate UE 601 to keep a TA value of the source cell after switching from the source cell to the target cell.

FIG. 7 illustrates an exemplary flowchart of maintaining a TA value in accordance with some embodiments of the present application. Details described in all other embodiments of the present application are applicable for the embodiments shown in FIG. 7.

As shown in FIG. 7, BS 705 is in CU-DU architecture, and includes CU 704, source DU 702, and candidate DUs 703 and 706. In the embodiments shown in FIG. 7, a cell switch or change of UE 701 may refer to an Intra-DU case in which a source cell and a target cell in the same DU or refer to an Inter-DU case in which a source cell and a target cell are located at different DUs. For instance, the flowchart 700 as shown in FIG. 7 only shows a cell change in an Inter-DU case for the exemplary purpose.

In the exemplary flowchart 700 as shown in FIG. 7, in operation 711, UE 701 may access the serving BS (e.g. gNB) and send a measurement report to the serving BS, for example, BS 705. The serving BS may include a CU (e.g. gNB-CU) and one or more DUs (e.g. gNB-DUs). A serving cell is associated with a CU and a DU. There is an F1 interface between the DU and the CU. For example, as shown in FIG. 7, BS 705 includes CU 704, source DU 702, and candidate DU 703. BS 705 may include one or more other candidate DUs (e.g. candidate DU(s) 706).

In operation 712, CU 704 may determine to initiate inter-cell L1/L2 based triggered mobility (LTM) configuration and transmit a request message, e.g. a UE CONTEXT SETUP REQUEST message to one or more candidate DUs (e.g. candidate DU 703) which are associated with one or more candidate cells. For example, the request message may be named as “a request for cell switching” or “the request of LTM configuration” or the like, and may include ID information of candidate cell(s).

In operation 713, if candidate DU 703 decides to accept the request of LTM configuration, candidate DU 703 may generate lower layer RRC configuration for the accepted one or more candidate cell(s) and send a response message to CU 704 including the generated lower layer RRC configuration. The response message could be a UE CONTEXT SETUP RESPONSE message.

In operation 714, CU 704 may generate an RRCReconfiguration message based on the configuration for the accepted candidate cell(s) received from candidate DU 703 and transmit the RRCReconfiguration message associated with the candidate cell(s) for LTM configuration to UE 701 via source DU 702.

In operation 715, UE 701 may receive information to trigger TA acquisition to a candidate cell within the candidate cell(s) from source DU 702. In some embodiments, the information could be DCI, a MAC CE or RRC signaling. If the information is DCI, it could be a PDCCH order.

In operation 716, UE 701 may transmit a signal (e.g. a sequence, for example, a dedicated preamble or a SRS) for TA acquisition, e.g. to candidate DU 703 and/or candidate DU(s) 706.

In operation 717, after a candidate cell of candidate DU 703 successfully receives the signal, e.g. a dedicated preamble, candidate DU 703 may calculate or generate a TA value associated with the candidate cell.

In operation 718, candidate DU 703 may transmit a message, which includes the calculated TA value, ID information of the corresponding candidate cell, and/or ID information of UE 701, to CU 704 via F1 interface. The F1 message may be an UL RRC MESSAGE TRANSFER message or a UE Context Modification Request message. In some embodiments, if one or more candidate cells are associated with candidate DU 703, candidate DU 703 may calculate one or more TA values, and transmit the TA values, ID information of the one or more candidate cells, and/or ID information of UE 701 to CU 704 via F1 interface.

In operation 719, after CU 704 receives the TA value(s) from candidate DU 703, CU 704 may transmit the TA value(s) to source DU 702. In some embodiments, CU 704 will transmit the TA value(s), ID information of the corresponding candidate cell(s), and/or ID information of UE 701 to source DU 702 via F1 interface. In operation 719, source DU 702 may receive one or more TA values associated with one or more candidate cells of one or more candidate DUs (e.g. including candidate DU 703 and/or candidate DU(s) 706 and/or other candidate DUs).

In operation 720, source DU 702 may transmit a cell switching command including ID information of a candidate cell (e.g. a candidate cell of candidate DU 703) to UE 701. After UE 701 receives the cell switching command, UE 701 may access the candidate cell of candidate DU 703 (i.e. the target cell) based on the cell switching command.

After operation 720, there may be following two options in different embodiments, i.e. Option X and Option Y.
(1) Option X: In operation 721B (optional), source DU 702 may transmit a TA list and ID information of candidate cell(s) to the candidate cell of candidate DU 703 (i.e. the target cell) to which UE 701 switches from the source cell.
   a) In some embodiments, in operation 721A (optional), CU 704 may transmit a request of providing the TA list to source DU 702, if CU 704 receives an indication from the candidate cell of candidate DU 703 (i.e. the target cell) to which UE 701 accesses. The indication could be “a cell switching success indication” or “a request of TA value transferring”. In response to reception of the request from CU 704 in operation 721A, source DU 702 may transmit the TA list and ID information of the corresponding candidate cell(s) to the candidate cell (i.e. the target cell).
(2) Option Y: In operation 722A (optional), after source DU 702 transmits the cell switching command to UE 701, source DU 702 may indicate ID information of the candidate cell (i.e. the target cell) to CU 704. For example, source DU 702 indicates to CU 704 that UE 701 switches to the candidate cell of candidate DU 703. In operation 722B (optional), CU 704 may inform other candidate DU(s) (e.g. candidate DU(s) 706) the ID information of the candidate cell (i.e. the target cell) to which UE 701 accesses.

FIG. 8 illustrates another exemplary flowchart of maintaining a TA value in accordance with some embodiments of the present application. Details described in all other embodiments of the present application are applicable for the embodiments shown in FIG. 8.

As shown in FIG. 8, BS 805 is in CU-DU architecture, and includes CU 804, source DU 802, and candidate DUs 803 and 806. In the embodiments shown in FIG. 8, a cell switch or change of UE 801 may refer to an Intra-DU case in which a source cell and a target cell in the same DU or refer to an Inter-DU case in which a source cell and a target cell are located at different DUs. For instance, the flowchart 800 as shown in FIG. 8 only shows a cell change in an Inter-DU case for the exemplary purpose.

In the exemplary flowchart 800 as shown in FIG. 8, in operation 811, UE 801 may access the serving BS (e.g. gNB) and send a measurement report to the serving BS, for example, BS 805. The serving BS may include a CU (e.g. gNB-CU) and one or more DUs (e.g. gNB-DUs). A serving cell is associated with a CU and a DU. There is an F1 interface between the DU and the CU. For example, as shown in FIG. 8, BS 805 includes CU 804, source DU 802, and candidate DU 803. BS 805 may include one or more other candidate DUs (e.g. candidate DU(s) 806).

In operation 812, CU 804 may determine to initiate inter-cell L1/L2 based triggered mobility (LTM) configuration and transmit a request message, e.g. a UE CONTEXT SETUP REQUEST message, to candidate DU(s) (e.g. candidate DU 803) which are associated with candidate cell(s). For example, the request message may be named as “a request for cell switching” or “the request of LTM configuration” or the like, and may include ID information of candidate cell(s).

In the exemplary flowchart 800, a subsequent LTM procedure after a LTM procedure may be supported. For instance, after a cell switching procedure, UE 801 may continue to keep candidate cell configuration(s) associated with some candidate cell(s) for subsequent LTM purpose. In some embodiments, CU 804 may transmit a candidate cell list to UE 801, e.g. in operation 812, and UE 801 may store candidate cell configuration(s) associated with each candidate cell within the candidate cell list after UE 801 switches from the source serving cell to a target cell (e.g. a candidate cell of candidate DU 803). UE 801 may switch from the target cell to another target cell (i.e. performing a subsequent LTM procedure) by using the stored candidate cell configuration(s) associated with the candidate cell list. The candidate cell list for which UE 801 will store candidate cell configuration(s) after cell switching may be indicated to a target DU (e.g. candidate DU 803) which UE 601 accesses. The candidate list can be included in a UE CONTEXT SETUP REQUEST message or a UE CONTEXT MODIFICATION REQUEST message.

In operation 813, if candidate DU 803 decides to accept the request of LTM configuration, candidate DU 803 may generate lower layer RRC configuration for the accepted one or more candidate cell(s) and send a response message to CU 804 including the generated lower layer RRC configuration. The response message could be a UE CONTEXT SETUP RESPONSE message.

In operation 814, CU 804 may generate an RRC reconfiguration message based on the configuration for the accepted candidate cell(s) received from candidate DU 803 and transmit the RRC reconfiguration message associated with the candidate cell(s) for LTM configuration to UE 801 via source DU 802.

In operation 815, UE 801 may receive information, which triggers TA acquisition to a candidate cell within the candidate cell(s) (e.g. a candidate cell of candidate DU 803), from source DU 802. In some embodiments, the information could be DCI, a MAC CE or RRC signaling. If the information is DCI, it could be a PDCCH order.

In operation 816, UE 801 may transmit a signal (e.g. a sequence, for instance, a dedicated preamble or a SRS) for TA acquisition, e.g. to candidate DU 803 and/or candidate DU(s) 806.

In operation 817, after a candidate cell of candidate DU 803 successfully receives the signal, e.g. a dedicated preamble, candidate DU 803 may calculate or generate a TA value associated with the candidate cell.

In operation 818, candidate DU 803 may transmit a message, which includes the calculated TA value, ID information of the corresponding candidate cell, and/or ID information of UE 801, to CU 804 via F1 interface. The F1 message may be an UL RRC MESSAGE TRANSFER message or a UE Context Modification Request message. In some embodiments, if one or more candidate cells are associated with candidate DU 803, candidate DU 803 may calculate one or more TA values, and transmit the TA values, ID information of the one or more candidate cells, and/or ID information of UE 801 to CU 804 via F1 interface.

In operation 819, after CU 804 receives the TA value(s) from candidate DU 803, CU 804 may store the received TA value(s) and ID information of the corresponding candidate cell(s).

In operation 820, CU 804 may transmit the received TA value(s) to source DU 802. In some embodiments, CU 804 will transmit the TA value(s), ID information of the corresponding candidate cell(s), and/or ID information of UE 801 to source DU 802 via F1 interface. In some embodiments, source DU 802 may receive one or more TA values associated with one or more candidate cells of one or more candidate DUs (including candidate DU 803 and/or candidate DU(s) 806 and/or other candidate DUs) in operation 820.

In operation 821, source DU 802 may transmit a cell switching command including ID information of a candidate cell (e.g. a candidate cell of candidate DU 803) to UE 801.

In operation 822, after UE 801 receives the cell switching command, UE 801 may access the candidate cell of candidate DU 803 (i.e. the target cell) based on the cell switching command.

In operation 823, UE 801 may transmit a complete message to CU 804 or candidate DU 803 (i.e. the target DU).

In operation 824, CU 804 may transmit a TA list to candidate DU 803 (i.e. the target DU). The TA list may include TA value(s) associated with the corresponding candidate cell(s) and/or ID information of the corresponding candidate cell(s). In some embodiments, CU 804 may keep the TA list. In some embodiments, CU 804 may transmit the TA list to candidate DU 803 (i.e. the target DU) before or after UE 801 switches from the source serving cell to the candidate cell (i.e. target cell) of candidate DU 803.

In some embodiments, CU 804 can transmit the TA list based on one of the following situations:
(1) receiving an indication, which indicates that a cell switching command has been transmitted to UE 801, from source DU 802.
(2) receiving an RRC reconfiguration complete message from UE 801 via candidate DU 803 (i.e. the target DU).
(3) receiving an indication of successful LTM (e.g. information which indicate that the UE has switched to the candidate cell) from candidate DU 803 (i.e. the target DU), if UE 801 transmits a successful switching indication to candidate DU 803 (i.e. the target DU).

In operation 825, CU 804 may indicate to other candidate DU(s) to which UE 801 does not access, e.g. candidate DU(s) 806, that the cell switching to the candidate cell (i.e. the target cell) of candidate DU 803 is completed.

In some embodiments, after successfully cell switching to the target cell, CU 804 should indicate, to other candidate DU(s), the ID information of the target cell to which UE 801 accesses. For example, there may be following options in different embodiments as below, i.e. Option A, Option B, and Option C.
(1) Option A: After UE 801 cell switching to the target cell, CU 804 may receive the complete message from UE 801 via candidate DU 803 (i.e. the target DU). Then, CU 804 may indicate to candidate DU(s) 806 that the cell switching to the target cell is completed.
(2) Option B: After UE 801 cell switching to the target cell, candidate DU 803 (i.e. the target DU) will receive a L2 complete message, e.g. MAC CE. Then, candidate DU 803 can trigger CU 804 to inform candidate DU(s) 806.
(3) Option C: After source DU 802 transmits the cell switching command to UE 801 in operation 821, source DU 802 can indicate, to CU 804, ID information of the candidate cell (i.e. the target cell) of candidate DU 803. For example, source DU 802 may indicate to CU 804 that UE 801 switches to the target cell. Then, CU 804 may transmit, to candidate DU(s) 806, ID information of the target cell to which UE 801 accesses.

FIG. 9 illustrates another exemplary flowchart of maintaining a TA value in accordance with some embodiments of the present application. Details described in all other embodiments of the present application are applicable for the embodiments shown in FIG. 9.

As shown in FIG. 9, BS 905 is in CU-DU architecture, and includes CU 904, source DU 902, and candidate DU 903. In the embodiments shown in FIG. 9, a cell switch or change of UE 901 may refer to an Intra-DU case in which a source cell and a target cell in the same DU or refer to an Inter-DU case in which a source cell and a target cell are located at different DUs. For instance, the flowchart 900 as shown in FIG. 9 only shows a cell change in an Inter-DU case for the exemplary purpose.

In the exemplary flowchart 900 as shown in FIG. 9, in operation 911, UE 901 may access the serving BS (e.g. gNB) and send a measurement report to the serving BS, for example, BS 905. The serving BS may include a CU (e.g. gNB-CU) and one or more DUs (e.g. gNB-DUs). A serving cell is associated with a CU and a DU. There is an F1 interface between the DU and the CU. For example, as shown in FIG. 9, BS 905 includes CU 904, source DU 902, and candidate DU 903. BS 905 may include one or more other candidate DUs (not shown in FIG. 9).

In operation 912, CU 904 may determine to initiate inter-cell L1/L2 based triggered mobility (LTM) configuration and transmit a request message, e.g. a UE CONTEXT SETUP REQUEST message, to candidate DU(s) (e.g. candidate DU 903) which are associated with candidate cell(s). For example, the request message may be named as “a request for cell switching” or “the request of LTM configuration” or the like, and may include ID information of candidate cell(s).

In operation 913, if candidate DU 903 decides to accept the request of LTM configuration, candidate DU 903 may generate lower layer RRC configuration for the accepted one or more candidate cell(s) and send a response message to CU 904 including the generated lower layer RRC configuration. The response message could be a UE CONTEXT SETUP RESPONSE message.

In operation 914, CU 904 may generate an RRC reconfiguration message based on the configuration for the accepted candidate cell(s) received from candidate DU 903 and transmit the RRC reconfiguration message associated with the candidate cell(s) for LTM configuration to UE 901 via source DU 902.

In operation 915, UE 901 may receive information to trigger TA acquisition to a candidate cell within the candidate cell(s) from source DU 902. In some embodiments, the information could be DCI, a MAC CE or RRC signaling. If the information is DCI, it could be a PDCCH order.

In operation 916, UE 901 may perform an RA procedure for TA acquisition, e.g. to candidate DU 903.

In operation 917, UE 901 may receive a random access response (RAR) message including a TA value for a certain candidate cell, e.g. from candidate DU 903. In some embodiments, UE 901 may receive one or more TA values associated with one or more candidate cells from candidate DU(s) (e.g. including candidate DU 903).

In operation 918, UE 901 may maintain or store a TA list of the corresponding candidate cell(s). The TA list may include TA value(s) associated with the candidate cell(s) and/or ID information the candidate cell(s) from one or more candidate DUs.

In operation 919, UE 901 may receive a cell switching command to a candidate cell (i.e. a target cell, e.g. a candidate cell of candidate DU 903) from source DU 902. In operation 920, UE 901 may access the target cell based on the cell switching command.

After operation 920, there may be following options in different embodiments as below, i.e. Option 1 and Option 2.
(1) Option 1: In operation 921, after cell switching to the target cell, UE 901 may release all TA value(s) for the corresponding candidate cell(s).
(2) Option 2: After cell switching to the target cell, UE 901 may be expected to maintain or store the TA value(s) for the corresponding candidate cell(s). In operation 922A (optional), the network may transmit an indication regarding candidate cell(s) a TA value associated with which needs to be maintained by UE 901 after cell switching. The indication can be included in RRC configuration information. In operation 922B (optional), if the TA value(s) for the corresponding candidate cell(s) are maintained or stored by UE 901, UE 901 may transmit information, which indicates a list of candidate cells, to the target serving cell, and UE 901 stores a TA value of each candidate cell within the list of candidate cells.

FIG. 10 illustrates a block diagram of an exemplary apparatus 1000 in accordance with some embodiments of the present application. As shown in FIG. 10, the apparatus 1000 may include at least one processor 1006 and at least one transceiver 1002 coupled to the processor 1006. Although in this figure, elements such as the at least one transceiver 1002 and processor 1006 are described in the singular, the plural is contemplated unless a limitation to the singular is explicitly stated. In some embodiments of the subject application, the transceiver 1002 may be divided into two devices, such as a receiving circuitry and a transmitting circuitry. In some embodiments of the subject application, the apparatus 1000 may further include an input device, a memory, and/or other components.

In some embodiments of the subject application, the apparatus 1000 may be a UE or a network node (e.g. a BS, a CU, or a DU). The transceiver 1002 and the processor 1006 may interact with each other so as to perform the operations with respect to the UE or the network node described above, for example, in any of FIGS. 1-9.

In some embodiments of the subject application, the apparatus 1000 may further include at least one non-transitory computer-readable medium. For example, in some embodiments of the present disclosure, the non-transitory computer-readable medium may have stored thereon computer-executable instructions to cause the processor 1006 to implement the method with respect to a UE or a network node (e.g. a BS, a CU, or a DU) as described above. For example, the computer-executable instructions, when executed, cause the processor 1006 interacting with transceiver 1002 to perform the operations with respect to the UE or the network node described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A centralized unit (CU) of a base station (BS), comprising:
at least one memory; and
at least one processor coupled with the at least one memory and configured to cause the CU to:
transmit a request for cell switching including identifier (ID) information of one or more candidate cells to one or more candidate distributed units (DU)s of the base station;
receive radio resource control (RRC) configuration information for the one or more candidate cells from the one or more candidate DUs; and
transmit an RRC reconfiguration message associated with the one or more candidate cells via to a user equipment (UE).

2. The CU of claim 1, wherein the at least one processor is configured to cause the CU to:
receive a first message from the UE or from a candidate DU within the one or more candidate DUs, wherein the UE is configured to switch from a source cell to a candidate cell within the one or more candidate cells; and
in response to receiving the first message, transmit a request for providing a timing advance (TA) list to a source DU, wherein the TA list includes at least one of the following:
one or more TA values associated with the one or more candidate cells; or
information of the one or more candidate cells.

3. The CU of claim 1, wherein a first message from the UE or a candidate DU of one or more candidate DUs includes at least one of the following:
information to indicate that the UE has switched to a candidate cell of one or more candidate cells; or
a request a timing advance (TA) list.

4. The CU of claim 1, wherein the at least one processor is configured to cause the CU to:
receive a timing advance (TA) list from a source DU; and
transmit the TA list to a candidate DU of one or more candidate DUs.

5. The CU of claim 1, wherein the at least one processor is configured to cause the CU to:
receive one or more timing advance (TA) values associated with the one or more candidate cells from the one or more candidate DU.

6. The CU of claim 1 claim 5, wherein the at least one processor is configured to cause the CU to transmit a TA list of the UE to a candidate DU of the base station, wherein the UE is configured to switch from a source cell of a source DU of the base station to a candidate cell of the candidate DU, and wherein the TA list includes at least one of the following:
one or more TA values; or
ID information of the one or more candidate cells.

7. The CU of claim 6, wherein the TA list is transmitted after the at least one processor is configured to cause the CU to receive one of the following:
information from the source DU to indicate that a cell switching command has been transmitted from the source DU to the UE;
an RRC reconfiguration complete message from the UE via the candidate DU of the base station BS; and
information from the UE via the candidate DU to indicate that the UE has switched to the candidate cell.

8. The CU of claim 1, wherein, in response to the UE switching from a source cell to a candidate cell within the one or more candidate cells, the at least one processor is configured to cause the CU to indicate ID information of the candidate cell to other candidate DUs within the one or more candidate cells.

9. The CU of claim 8, wherein the at least one processor is configured to cause the CU to receive at least one of the following:
information from the UE via the candidate DU to indicate that the UE has switched to the candidate cell;
information from a candidate DU of the BS to indicate that the candidate DU has received a Layer2 (L2) cell switching complete message associated with the candidate cell; or
ID information of the one or more candidate cells and ID information of the candidate cell from a source DU.

10. A user equipment (UE), comprising:
at least one memory; and
at least one processor coupled with the at least one memory and configured to cause the UE to:
receive a timing advance (TA) value associated with a source cell from the source cell;
receive a cell switching command to a candidate cell within the one or more candidate cells from the source cell; and
access the candidate cell based on the cell switching command.

11. The UE of claim 10, wherein, after the UE switches from the source cell to the candidate cell, the at least one processor of the UE is configured to cause the UE to perform at least one of the following:
continuing to keep the TA value associated with the source cell; or
maintaining a time alignment timer (TAT) associated with the source cell.

12. The UE of claim 11, wherein the source cell acts as one candidate cell after the UE switches from the source cell to the candidate cell.

13. The UE of claim 11, wherein the at least one processor is configured to cause the UE to receive first information from the source cell, and wherein the first information indicates at least one of the following:
whether to keep the TA value associated with the source cell; or
whether to maintain the TAT associated with the source cell.

14. The UE of claim 10, wherein, after the UE switches from the source cell to the candidate cell, the at least one processor is configured to cause the UE to:
release the one or more TA values associated with the one or more candidate cells; or
continue to keep all or a subset of the one or more TA values associated with the one or more candidate cells.

15. A candidate distributed unit (DU) of a base station, comprising:
at least one memory; and
at least one processor coupled with the at least one memory and configured to cause the candidate DU to:
transmit a first message via the transceiver to the CU, wherein the first message includes at least one of the following:
information indicating that a user equipment (UE) has switched from a source cell of a source DU of the BS to a candidate cell within a set of candidate cells of the candidate DU; or
a request of a timing advance (TA) list.

16 A source distributed unit (DU) of a base station, comprising:
at least one memory; and
at least one processor coupled with the at least one memory and configured to cause the source DU to:
receive a timing advance (TA) list via the transceiver from a centralized unit (CU) of the base station, wherein the TA list includes at least one of the following:
one or more TA values associated with one or more candidate cells of one or more candidate DUs of the base station; or
identifier (ID) information of the one or more candidate cells; and
transmit a cell switching command to a candidate cell within the one or more candidate cells to a user equipment (UE).

17. The source DU of claim 16, wherein the at least one processor is configured to cause the source DU to transmit the TA list to the CU.

18. The source DU of claim 16, wherein the at least one processor is configured to cause the source DU to, after transmitting the cell switching command, transmit ID information on the candidate cell to the CU.

19. The UE of claim 10, wherein the at least one processor is configured to cause the UE to keep candidate cell configurations associated with one or more candidate cells from the one or more candidate cells.

20. The UE of claim 10, wherein the at least one processor is configured to cause the UE to receive one or more TA values associated with one or more candidate cells from the one or more candidate cells.
